(19) United States
(12) Patent Application Publication
(10) Pub. No.: US 2005/0193428 A1
(43) Pub. Date: Sep. 1, 2005

(54) Method, system, and computer-readable medium for recovering from an operating system exploit

(76) Inventors: Sandra E. Ring, Alexandria, VA (US); Eric B. Cole, Leesburg, VA (US)

Correspondence Address: TIMOTHY J MARTIN, PC, 9250 W 5TH AVENUE, SUITE 200, LAKEWOOD, CO, 80226, US

(21) Appl. No.: 10/872,136

(22) Filed: Jun. 17, 2004

Related U.S. Application Data
(62) Division of application No. 10/789,460, filed on Feb. 26, 2004.

(51) Int. Cl. G06F 12/14

(52) U.S. Cl. 726/22

(57) ABSTRACT

Methods, systems and computer-readable media are provided for recovery from an operating system (OS) exploit so that the OS can be returned to a pre-exploit condition. Recovery involves restoration of each system call table modification which has been identified, the termination of each hidden process which has been identified, and the removal from the OS of each hidden file which has been identified.

### BACKGROUND OF THE INVENTION

The present invention generally relates to the restoration of a computer system that has been exploited, such as through an operating system attack from a surreptitious rootkit installation. To this end, the invention broadly pertains to the areas of operating system repair and maintenance.

The continual increase of exploitable software on computer networks has led to an epidemic of malicious activity by hackers and an especially hard challenge for computer security professionals. One of the more difficult and still unsolved problems in computer security involves the detection of exploitation and compromise of the operating system itself. Operating system compromises are particularly problematic because they corrupt the integrity of the very tools that administrators rely on for intruder detection.

A rootkit is a common name for a collection of software tools that provides an intruder with concealed access to an exploited computer. Rootkits are often used in conjunction with sophisticated command and control programs frequently referred to as “backdoors.” A backdoor is the intruder's secret entrance into the computer system that is usually hidden from the administrator by the rootkit. Backdoors can be implemented via simple TCP/UDP/ICMP port listeners or via incorporation of complex stealthy trigger packet mechanisms. In addition to hiding the binary itself, rootkits are typically capable of hiding the backdoor's process and network connections as well.

Rootkits are generally classified into two categories—application level rootkits and kernel modifications. To the user, the behavior and properties of both are identical, the only real difference being their implementation. Many application level rootkits operate by physically replacing or modifying files on the hard drive of the target computer. Kernel rootkits have similar capabilities, but function quite differently. Kernel level rootkits consist of programs capable of directly modifying the running kernel itself. They are much more powerful and difficult to detect because they can subvert any application level program, without physically “trojaning” it, by corrupting the underlying kernel functions. Instead of trojaning programs on disk, kernel rootkits generally modify the kernel directly in memory as it is running. Intruders will often install them and then securely delete the file from the disk using a utility such as fwipe or overwrite. This can make detection exceedingly difficult because there is no physical file left on the disk.

The continual creation of new and unproven software inevitability produces exploitable flaws and vulnerabilities. Because these flaws are unpredictable it becomes important to implement adequate prevention measures, such as firewalls and intrusion detection systems, aimed at thwarting attacks. Current computer network protection techniques are similar to what the human body provides as perimeter defense mechanisms. For instance, the skeleton protects precious organs, layers of skin protect inner networks of nerves and vessels, and multiple flushing mechanisms protect against dangerous bacteria.

However, the human body does not stop at perimeter protection as computer security typically does. It implements the notion of defense in depth and offers many additional layers of protection. Specifically it provides a key element that computer network protection does not—an immune and healing system. What the human body cannot prevent it can actually heal and recover from. Nature has conceded to the notion that not all outside attacks are preventable, as should operating system developers and security architects. Accordingly, it is also important that defensive mechanisms, such as firewalls and intrusion detection systems, also be paired with practical remediation techniques to provide optimum results.

The most powerful method of operating system protection undoubtedly occurs when the administrator conducts an initial baseline following a trusted installation, installs a powerful prevention system that is capable of sensing attacks as they occur, and frequently updates the baseline according to each change on the system. Unfortunately this approach is not always practical because many administrators work with systems that have been previously installed, and the workload of constant baselining can quickly become overwhelming. Moreover, it can also difficult to convince many of the importance of dedicating security resources to a system prior to any incidents. To date, the standard technique for recovery without a trusted baseline is to re-install the entire operating system. This method is costly, time consuming, and can destroy critical forensic evidence. It appears that most other “recovery” methodologies are conducted by first turning the computer off and physically analyzing files on the hard drive.

Despite one's best efforts, current remediation/self-healing techniques also have inherent limitations. Because the action of self-healing occurs completely after the fact of the incident, there is no way of knowing exactly what actions the attacker took before the self-healing occurred. The attacker may have triggered an entire chain of events that cannot be recovered from because the past cannot be changed. For instance, once the attacker gained root access on the operating system, he/she may have accessed sensitive user names and passwords that they can use to leverage for additional access, or they may have altered critical numbers within a sensitive database. Without prior installation or baselining before the attack, there is no means of identifying that this exposure has taken place. In addition, the attacker may have permanently overwritten critical components of the operating system that can only be recovered with restoration from a back up or re-installation.

These known drawbacks, thus, give rise to a further need to provide an improved and more intuitive approach to operating system restoration following an exploit, and the present invention is directed to satisfying this need.

### BRIEF SUMMARY OF THE INVENTION

In its various embodiments, the present invention relates to a computerized method, a system, and a computer readable medium for recovery from an operating system (OS) exploit. Preferably, each is suitably adapted for use with an exploitation detection component capable of identifying each system call table modification, each hidden process and each hidden file that is associated with the exploit.

According to the computerized method, the operating system is returned to a pre-exploit condition by, in any order, restoring each system call table modification which has been identified, terminating each hidden process which has been identified, and removing from the operating system each hidden file which has been identified. Output may be generated indicative of each system call table modification that has been restored, each hidden process that has been terminated, and each hidden file which has been removed. In the context of the invention, each system call table modification corresponds to a legitimate look up address for a respective system call table function being patched over with an illegitimate look up address. Accordingly, restoration of each system call table modification entails replacing the illegitimate look up address with the legitimate look up address. Also in the context of the invention, each respective hidden process is characterized by a memory management structure, a file descriptor structure and a file system structure. Termination of each respective hidden process entails removal of all pointers to these various structures. Thereafter, a termination signal is preferably transmitted to each hidden process.

The system of the present invention comprises storage means, output means and processing means for accomplishing restoration of each system call table modification, termination of each hidden process and removal of each hidden file. The computer-readable medium of the invention preferably comprises a loadable kernel module having executable instructions for performing such a methodology.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 represents a high level diagrammatic view of an exemplary security software product which incorporates the operating system (OS) restoration component of the present invention;

FIG. 2 represents a high level flow chart for computer software which incorporates the OS restoration component;

FIG. 3 is a high level flow chart diagrammatically illustrating the principle features for the OS restoration component of the invention;

FIG. 4 is a high level flow chart for computer software which implements the functions of the kernel module for the OS restoration component;

FIG. 5 represents a flow chart for computer software which implements the functions of the system call table recovery routine that is associated with the OS restoration component of the present invention;

FIG. 6 represents a flow chart for computer software which implements the functions of the hidden process recovery routine that is associated with the OS restoration component;

FIG. 7 represents a flow chart for computer software which implements the functions of the hidden files recovery routine that is associated with the OS restoration component; and

FIGS. 8(a)-(g) are each representative output results obtained when the OS restoration component described in FIGS. 3-7 was applied against an unexploited system (FIG. 8(a) 36(a)), as well a system exploited with the Adore kernel level rootkit (FIGS. 8(b)-(g).

### DETAILED DESCRIPTION OF THE INVENTION

### I. Introduction

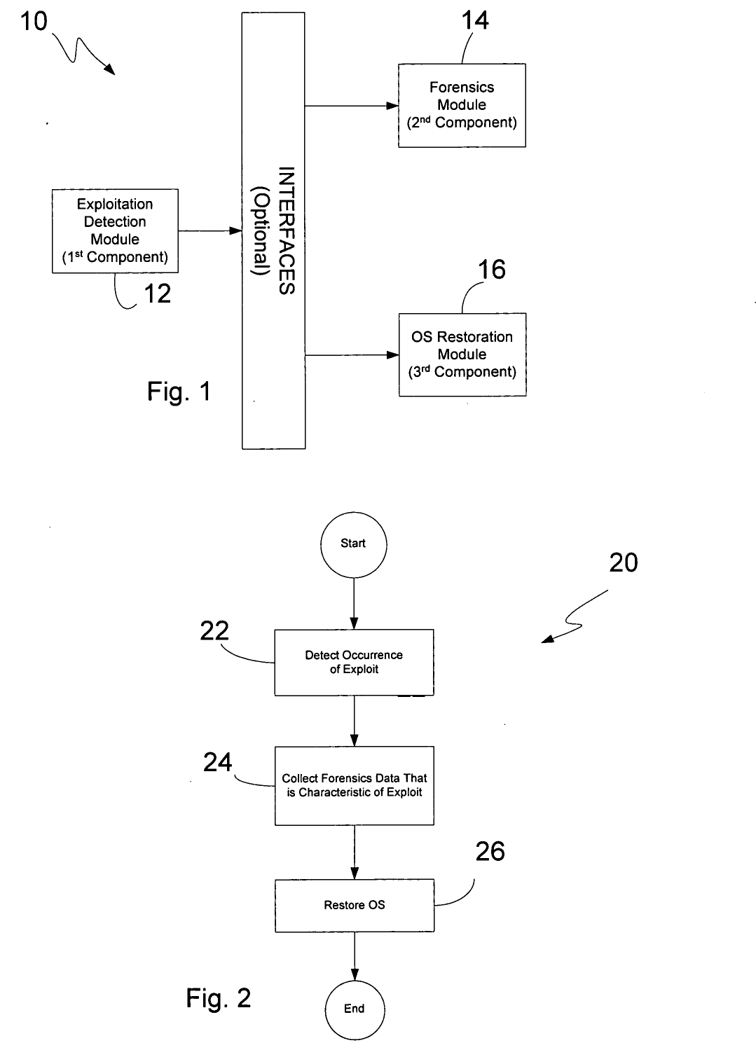

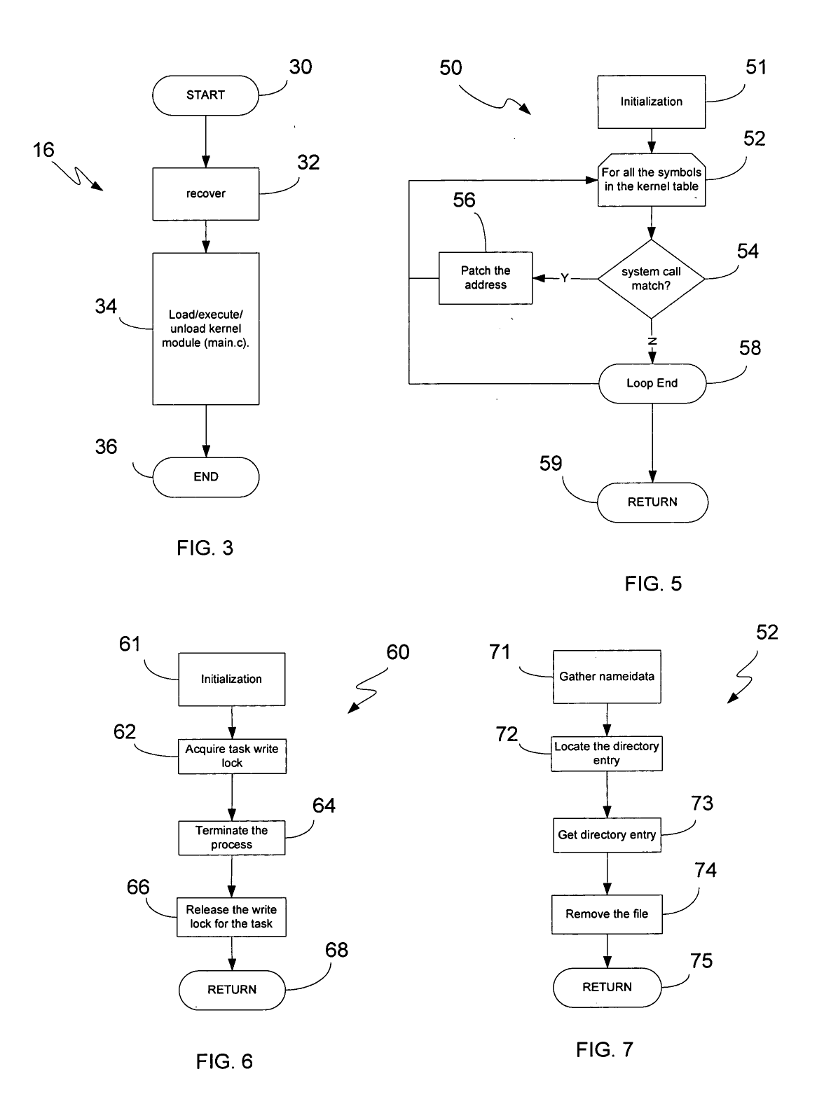

Aspects of this invention provide a software component, sometimes referred to herein as an operating system (OS) restoration component or module, which may be used as part of a system, a computer-readable medium, or a computerized methodology. This component was first introduced as part of a suite of components for handling operating system exploitations in our commonly owned, parent application Ser. No. 10/789,460 filed on Feb. 26, 2004, and entitled “Methodology, System, Computer Readable Medium, And Product Providing A Security Software Suite For Handling Operating System Exploitations”, which is incorporated by reference in its entirety. As discussed in that parent application, and as illustrated in FIG. 1 here, the OS restoration component 16 may be part of a product or system 10 whereby it interfaces with other components 12 & 14. The components 12 & 14, respectively detect exploitation and collect forensics data pertaining to the exploitation. The exploit detection module 12 is the subject of our co-pending, and commonly owned, application Ser. No. 10/789,413 filed on Feb. 27, 2004. The forensics data collection component 14 is the subject of our co-pending, and commonly owned, application Ser. No. 10/804,469 filed on Mar. 18, 2004. As shown in FIG. 2, the functionalities 26 of the OS restoration component of the present invention may be used as part of a overall methodology 20 which also includes the functionalities 22 & 24 that are respectively associated with detecting occurrence of an OS exploit and collecting forensics data that is characteristic of the exploit.

The OS restoration component 16 (FIGS. 2 & 3, above) presents an approach to recovering from operating system exploits without previous base lining or installation of defensive software. This model can be paired with virtually any detection technique, including the exploitation detection component discussed above, and described in greater detail in our parent application, to be used as either a reactive or proactive system. The OS restoration component 16 is implemented “after the fact”, meaning that it is used as a remediation technique and not as a preventative measure. The system can be executed when an intrusion is suspected so that the operating system can be returned to a “pre-compromise” or “pre-exploit” state. In such a circumstance, for example, an administrator may sense that something is amiss on the computer system and desire a means of acceptable recovery. According to the OS restoration component, operating system structures are returned to their original installation values, and intruder processes and files are halted or removed. More particularly, functionalities are provided for the termination of hidden processes, the removal of hidden files, and repair of the kernel from system call table based rootkit attacks. The functionality for computer software routines which implements these capabilities is described below. The ordinarily skilled artisan will recognize that these concepts can also be further expanded, without departing from the inventive teachings contained herein, in order perhaps to build more robust capabilities for recovering from more complex attacks.

Moreover, the artisan will appreciate that, while the description of the restoration component below is one which leverages virtually any detection technique and which is used “after the fact” (i.e., similar to taking an antibiotic drug to fight an infection), it could also be integrated directly into the operating system (i.e., to fight infections automatically like an immune system), or as a combination of both. In the future it can be extended to include an adaptation component. In this case the operating system would be capable of “learning” from the attack, and growing immune if faced with the same or similar situation again. This is analogous to how the body is capable of growing immune to certain diseases following a previous exposure. Ideally the same will be true some day for computer defenses as well.

In addition to being more efficient and practical than traditional reinstallation, the OS restoration component provides a means of automating the entire recovery process. Paired with the exploitation detection and forensics data collection components, if desired, operating system compromises can be automatically recovered from “on-the-fly” with little or no administrator intervention. Likewise the healing mechanisms presented here can be expanded to provide an adaptation capability to prevent future attacks.

The self-healing mechanism described here is based on the hybrid anomaly detection technique derived from a set of operating systems premises initially introduced in our parent application Ser. No. 10/789,460 with respect to the exploitation detection component. These premises are:
Premise 1: All kernel calls should only reference addresses located within normal kernel memory.
Premise 2: Memory pages in use indicate a presence of functionality or data.
Premise 3: A process visible in kernel space should be visible in user space.
Premise 4: All unused ports can be bound to.
Premise 5: Persistent files must be present on the file system media.

This component similarly uses the successes of immunology to identify fundamental flaws in the behavior of a compromised operating system. Accepting the limitation that this component will not be capable of restoring mortal actions taken or undoing untraceable actions prior to the start of self-healing, it makes its best attempt at recovery from the majority of operating system compromises. Currently it is capable of restoring the system call table, terminating hidden processes, and removing hidden files.

In the following detailed description, reference is made to the accompanying drawings which form a part hereof, and in which is shown by way of illustrations specific embodiments for practicing the invention. The leading digit(s) of the reference numbers in the figures usually correlate to the figure number; one notable exception is that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Various terms are used throughout the description and the claims which should have conventional meanings to those with a pertinent understanding of computer operating systems, namely Linux, and software programming. Other terms will perhaps be more familiar to those conversant in the areas of intrusion detection, computer forensics and systems repair/maintenance. While the description to follow may entail terminology which is perhaps tailored to certain OS platforms or programming environments, the ordinarily skilled artisan will appreciate that such terminology is employed in a descriptive sense and not a limiting sense. Where a confined meaning of a term is intended, it will be set forth or otherwise apparent from the disclosure.

In one of its forms, the present invention provides a system for OS restoration that is implemented on a computer which typically comprises a random access memory (RAM), a read only memory (ROM), and a central processing unit (CPU). One or more storage device(s) may also be provided. The computer typically also includes an input device such as a keyboard, a display device such as a monitor, and a pointing device such as a mouse. The storage device may be a large-capacity permanent storage such as a hard disk drive, or a removable storage device, such as a floppy disk drive, a CD-ROM drive, a DVD-ROM drive, flash memory, a magnetic tape medium, or the like. However, the present invention should not be unduly limited as to the type of computer on which it runs, and it should be readily understood that the present invention indeed contemplates use in conjunction with any appropriate information processing device, such as a general-purpose PC, a PDA, network device or the like, which has the minimum architecture needed to accommodate the functionality of the invention. Moreover, the computer-readable medium which contains executable instructions for performing the methodologies discussed herein can be a variety of different types of media, such as the removable storage devices noted above, whereby the software can be stored in an executable form on the computer system.

The source code for the software was developed in C on an x86 machine running the Red Hat Linux 8 operating system (OS), kernel 2.4.18. The standard GNU C compiler was used for converting the high level C programming language into machine code, and Perl scripts where also employed to handle various administrative system functions. However, it is believed the software program could be readily adapted for use with other types of Unix platforms such as Solaris®, BSD and the like, as well as non-Unix platforms such as Windows® or MS-DOS®. Further, the programming could be developed using several widely available programming languages with the software component(s) coded as subroutines, subsystems, or objects depending on the language chosen. In addition, various low-level languages or assembly languages could be used to provide the syntax for organizing the programming instructions so that they are executable in accordance with the description to follow. Thus, the preferred development tools utilized by the inventors should not be interpreted to limit the environment of the present invention.

A product embodying the present invention may be distributed in known manners, such as on computer-readable medium or over an appropriate communications interface so that it can be installed on the user's computer. Furthermore, alternate embodiments which implement the invention in hardware, firmware or a combination of both hardware and firmware, as well as distributing the software components and/or the data in a different fashion will be apparent to those skilled in the art. It should, thus, be understood that the description to follow is intended to be illustrative and not restrictive, and that many other embodiments will be apparent to those of skill in the art upon reviewing the description.

The invention has been employed by the inventors utilizing the development tools discussed above, with the software component being coded as a separate module which is compiled and dynamically linked and unlinked to the Linux kernel on demand at runtime through invocation of the init_module( ) and cleanup_module( ) system calls. As stated above, Perl scripts may be used to handle some of the administrative tasks associated with execution, as well as some of the output results. The ordinarily skilled artisan will recognize that the concepts of the present invention are virtually platform independent. Further, it is specifically contemplated that the functionalities described herein can be implemented in a variety of manners, such as through direct inclusion in the kernel code itself, as opposed to one or more modules which can be linked to (and unlinked from) the kernel at runtime. Thus, the reader will see that the more encompassing term “component” or “software component” are sometimes used interchangeably with the term “module” to refer to any appropriate implementation of programs, processes, modules, scripts, functions, algorithms, etc. for accomplishing these capabilities. Furthermore, the reader will see that terms such, “program”, “algorithm”, “function”, “routine” and “subroutine” are used throughout the document to refer to the various processes associated with the programming architecture. For clarity of explanation, attempts have been made to use them in a consistent hierarchical fashion based on the exemplary programming structure. However, any interchangeable use of these terms, should not be misconstrued as limiting since that is not the intent.

### II. OS Restoration Component

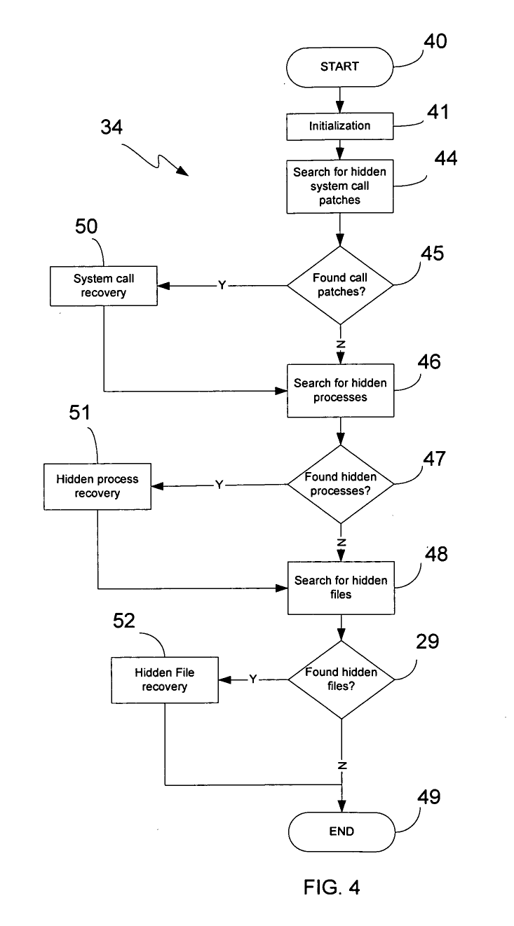

As introduced in FIG. 3, the OS restoration component may be implemented as a loadable kernel module for Linux 2.4.18. As discussed above, though, the technique can be applied to virtually any operating system because the general methodologies will be similar across different platforms. However, because this component is implemented at the kernel level, the specific implementation (i.e., coding) will be different. With more particular reference to FIG. 3, OS restoration component 16, preferably incorporates a prototype user interface 32, referred to as “recover” for ease of explanation, which is a “shell” script programmed in “/bin/sh”. Interface 32 is responsible for starting the associated kernel module (main.c.) 34. Restoration kernel module 34 is loaded, executed and then unloaded, and is the primary piece of the OS restoration component 16. It is responsible for recovering the OS from kernel system call table patches, hidden processes, and hidden files. After starting at 30, the flow for OS restoration component 16 terminates at 36 once its associated kernel module 34 completes execution.

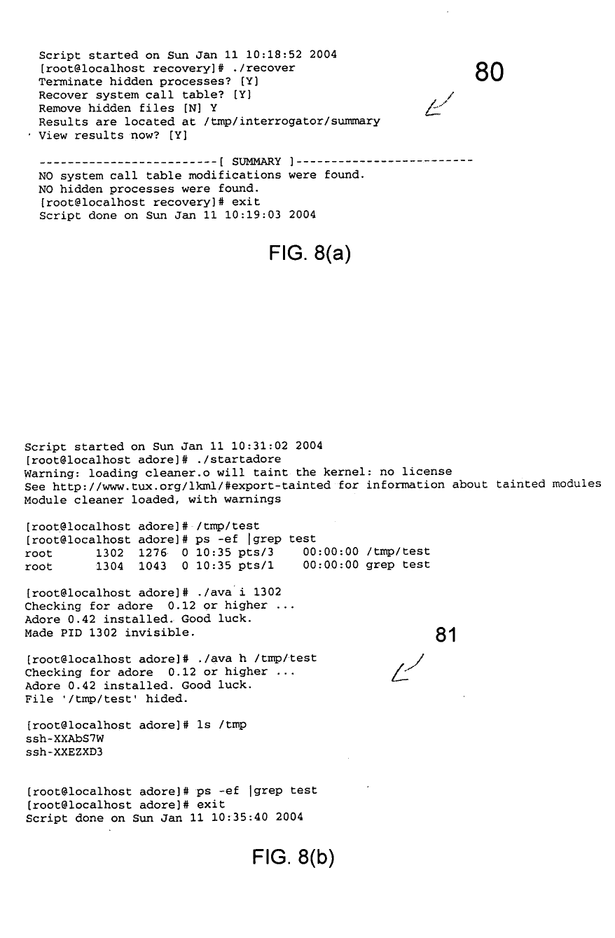

A high-level program flowchart for OS restoration kernel module 34 is shown in FIG. 4. Various functions incorporated into the restoration kernel module 34 are the same as those associated with the exploitation detection kernel module that is described in our parent application Ser. No. 10/789,460, generally with reference to FIGS. 4 & 8-19 thereof. As that application is incorporated by reference, a description of these functions need not be repeated for a complete understanding of the OS restoration component of the invention, except perhaps to explain them generally in the context of OS restoration. Thus, the description to follow will primarily only entail a discussion of those aspects of the OS restoration component which are unique to it.

With this in mind, once restoration kernel module 34 begins at 40 and initializes at 41, it proceeds to execute many of the same functionalities as the exploitation detection kernel module. For sake of clarity and ease of explanation, reference numerals in FIG. 4 here identify corresponding functionalities discussed with reference to FIG. 4 of the parent application. Following initialization 41, a function is called at 44 to search for hidden system call patches within the kernel's memory. If any system call patches are found at 45, a system call recovery algorithm 50 is initiated. The module then proceeds to search for hidden processes at 46. If any are found at 47, a hidden process recovery algorithm 51 is initiated. Finally, kernel module 34 searches at 48 for hidden files and calls an appropriate algorithm 52 to recover any which are found in response to inquiry 29. The program flow for kernel module 34 then ends at 49.

Since versatility can be provided to either interface the restoration kernel module 34 to an exploitation detection kernel module, such as described in the parent application, or to allow it to operate autonomously, functionality may be provide within the recovery component itself to permit this capability. FIG. 4 thus depicts a self-contained restoration component which, as such, replicates many of the functions associated with the exploitation detection component of the parent application so that it can function autonomously. Rather than generating output results, as occurred with the exploitation detection's kernel module, restoration kernel module 34 provides for various recovery algorithms 50-52, each based on results from a respective search 44, 46 and 48. These recovery routines will now be described.

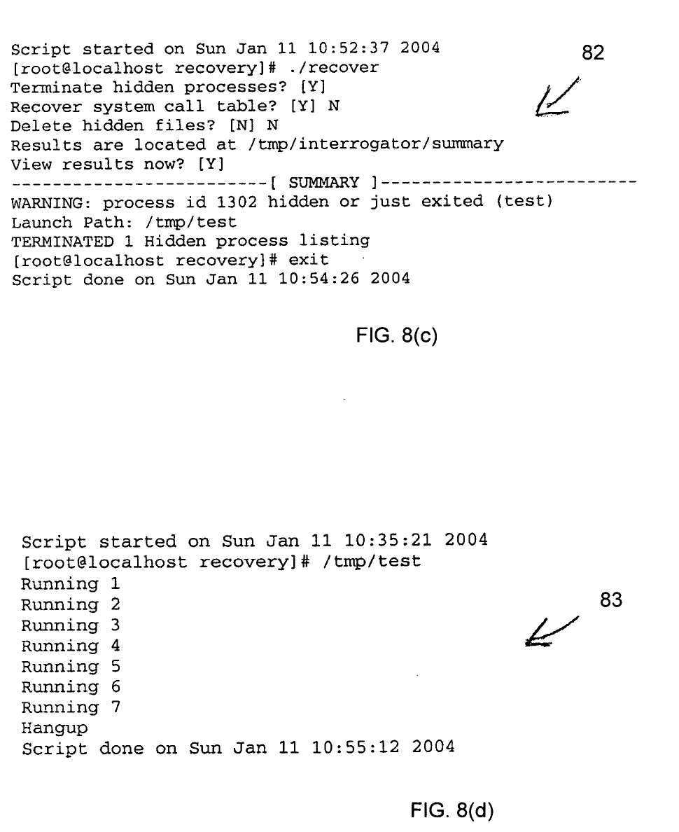

FIG. 5, thus, represents a flow chart for computer software implementing the system call table recovery algorithm 50 shown in FIG. 4. In operation, a pointer is made to the start of the kernel symbols. From this point each symbol is compared to see if it matches to the name of the system call in question. If it matches, the address of the function within the system call table is replaced with the address of the corresponding symbol. As more particularly shown in FIG. 5, initialization takes place at 51 when the algorithm is called to prepare the necessary data structures and pointers into the kernel symbol table. As an input it receives the name of the function within the system call table that has been modified. A loop is initiated at 52 through all names within the kernel symbol table. If the encountered name in the symbol table matches at 54 to the name of the patched system call table function, then the address of the symbol is patched over the modified address of the system call table at 56. Otherwise, once the loop has finished analyzing all names within the kernel symbol table, it ends at 58 and the algorithm returns at 59.

The strength of the system call table recovery function is its ability to heal the kernel from malicious software. Intruders generally “patch” over lookup addresses within the system call table to redirect legitimate applications to use their tainted software. This system repairs the system call table by replacing addresses that are determined to be malicious by a suitable detection module, such as described in the parent application. Although addresses for the system calls are not exported globally for general usage, they can be determined by searching through the kallsyms structure within kernel memory. The malicious addresses within the system call table can then be replaced with the legitimate addresses as described in FIG. 5.

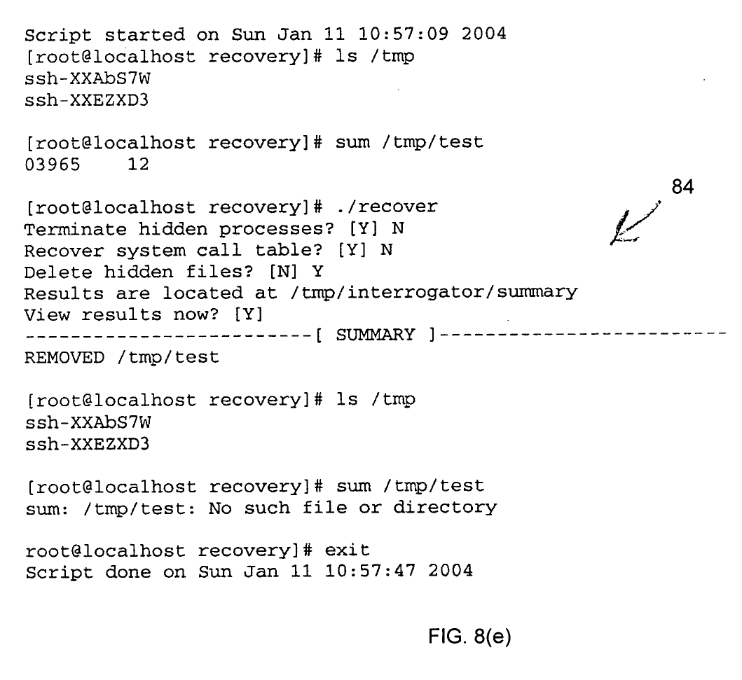

Once a process has been identified as hidden by an external detection component, it is available for termination by restoration component 16. The component can be configured to automatically terminate all hidden processes (i.e., no human intervention), automatically terminate only processes that match a particular criteria (i.e., a process that appears to be socket related or a process that appears to be a network traffic sniffer), or query the user to interactively terminate selected processes. The current embodiment depicted in FIG. 6 serves to terminate all processes that are hidden from the user. It operates by removing pointers to the memory management structure, file descriptor structure, file system structure, and sending a “hang up” signal to the process. This will force the process to immediately halt and cease functioning cleanly. The memory management structure (p->mm) is also set to NULL which will allow for the process to terminate as a coredump if the attacker has implemented signal handling internally to ignore external signals.

Reference is particularly made to FIG. 6. Upon initializing at 60, this function 61 receives the ID of a process that is hidden and therefore should be terminated. Again, appropriate data structures and pointers to memory for this process are prepared. At 62, the write lock for the task structure which references this process is acquired so that it can be modified. At 64 pointers are removed for the memory management, the file descriptors, the file system; and, the process task is assigned the “death signal”. This series of events effectively terminates the process and prevents it from further execution. The write lock for the process which has been terminated is then released, and algorithm 51 returns at 68.

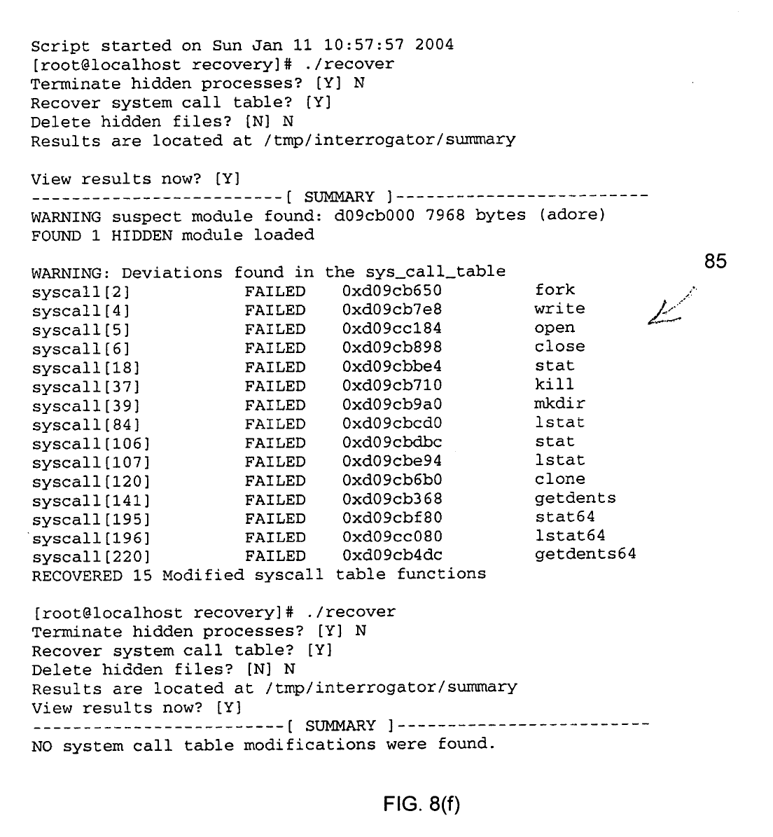

Finally, the hidden file removal algorithm 52 is shown in FIG. 7. This is another area of healing for a compromised system, and accomplishes removal of files that are otherwise invisible to administrators. It should be noted that this function is based on the open-source “removal” functionality within the Linux operating system. There is essentially only one way to remove the file from the kernel, as outlined by FIG. 7. At 71 the function initially receives, from the file system, the name of the file that should be removed. It starts by filling the nameidata structure with information via the space path_init( ) kernel function. At 72, traversal is made down all of the full path elements until the directory is reached which houses the file to be terminated. Once at the correct level, the kernel function lookup_hash( ) is called at 73 to obtain the pointer to the directory entry of the file. The kernel function vfs_unlink( ) is then called at 74 to remove the directory entry (i.e. the file) from the file system. Thereafter, function 52 completes and returns at 75.

In its current implementation, when the user executes this OS restoration component 16, the user is initially asked if hidden file removal is desired. If the user selects “NO” and only wishes to recover the system call table the file becomes “unhidden” by the mere fact that the intruder's kernel rootkit is no longer operating. While the component is currently only configured to remove a single file marked as “hidden” by the rootkit, it could easily be expanded to interactively query the user for each file, or even make copies of the files into a “quarantined” location prior to removing them from the system.

The functions described are capable of recovering or “disinfecting” against most popular kernel rootkits. Enhancements, however, could be made to expand the recovery capability to heal from more sophisticated “non-public” kernel attacks that do not operate by patching the system call table. One possible approach for doing this is to expand the kernel healing to implement a call graph table trace of all possible malicious patch points. For instance, the address of the system call will be determined through the approach demonstrated above. The function pointed to by the address will then be inspected to identify all assembly “CALL” or “JUMP” instructions. The address of each call will be recursively followed for their list of “CALL” or “JUMP” instructions. Eventually an exhaustive graph of all possible calls will be generated for each system call address. This graph can be inspected for addresses that fall outside the trusted kernel memory range, and their subsequent calling function can be repaired. Implementing this graphing capability should provide a mechanism to recover from all kernel modifications. It should be noted, however, that the success of this capability will be determined by the ability to determine replacement or recovery addresses for the modified functions.

Another type of enhancement could be the automated recovery of user space applications such as 1) trojaned programs and 2) vulnerable services. Healing from user space modifications is a simple process that merely requires replacing the infected application with a pristine version. However, this requires a database of pristine applications available for automated download and installation. As intruders are becoming more sophisticated and transitioning attacks from user space to kernel rootkits this may be less of a requirement.

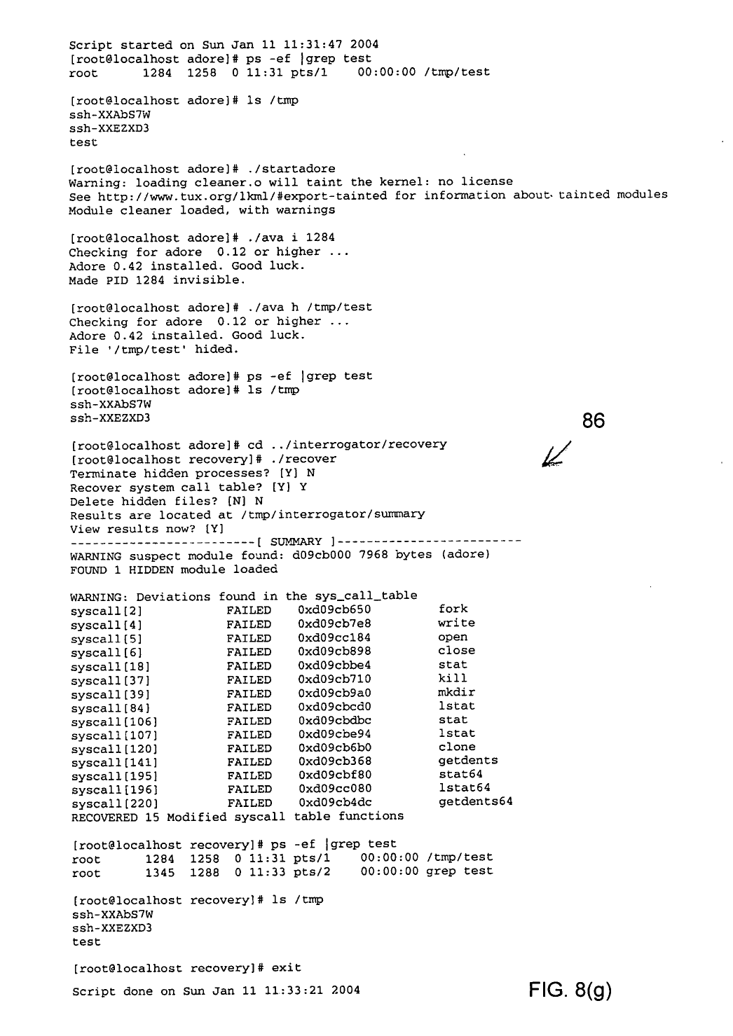

Having described in sufficient detail the OS restoration component 16, reference is now made to FIGS. 8(a)-38g) to illustrate representative results obtained when the component was tested against the Adore v.0.42 kernel rootkit. The system was first run against a clean installation of Linux 2.4.18 to generate a first results listing 80 shown in FIG. 8(a). Following a clean system test, the kernel rootkit Adore was installed, as illustrated by the listing 81 in FIG. 8(b). At this point it may be seen that the system call table has been modified, the process ID “1302” is hidden, and the file “/tmp/test” has been hidden.

The OS restoration component may first be used to terminate the process hidden by the rootkit. FIG. 8(c) shows the output 82 of running the program after the rootkit has been installed, and FIG. 8(d) shows the output 83 of the process as it was terminated. Next the OS restoration component was used to remove the file hidden by the rootkit. See output listing 84 of FIG. 8(e). Adore has the weakness that individual files can be listed if their name is known. Therefore, a checksum is run against the file before and after to prove that it was successfully deleted while hidden. Next, the recovery system was used to recover the system call table, as illustrated by results listing 85 in FIG. 8(f).

Finally, FIG. 8(g) illustrates output results 86 for a second recovery run against the system call table to demonstrate that it was repaired successfully and that the module Adore is no longer installed. This can also be demonstrated by recovering the system call table without terminating the hidden process or removing the hidden file. In this example the process ID “1284” and the file “/tmp/test” are both visible initially. The rootkit is then installed and both immediately become hidden from standard inspection methods. Following execution of the OS restoration component, both the process and the file become visible again. This is because the kernel has become “disinfected” from the kernel rootkit. The module is still located in memory, but all function calls to it have been disabled. In the future this system can be expanded to physically remove the function from memory as well.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A computerized method for recovering from an operating system exploit following detection thereof by an exploitation detection component, said computerized method for returning the operating system to a pre-exploit condition, said computerized method comprising, in any order:
(a) restoring each system call table modification identified by the exploitation detection component;
(b) terminating each hidden process identified by the exploitation detection component; and
(c) removing from the operating system each hidden file identified by the exploitation detection component.

2. A computerized method according to claim 1 comprising generating output indicative of each system call table modification which has been restored, each hidden process which has been terminated, and each hidden file which has been removed.

3. A computerized method according to claim 1 wherein each system call table modification corresponds to a legitimate lookup address for a respective system call table function being patched over with a illegitimate lookup address, and whereby restoration of each said system call table modification entails replacing the said illegitimate lookup address with the legitimate lookup address.

4. A computerized method according to claim 1 wherein each respective hidden process is characterized by a memory management structure, a file descriptor structure and a file system structure, and whereby termination of each respective hidden process entails removing all pointers to the memory management structure, the file descriptor structure and the file system structure.

5. A computerized method according claim 4 comprising thereafter transmitting a termination signal to the respective hidden process.

6. A computerized method for recovering from an operating system exploit following detection thereof by an exploitation detection component that is capable of identifying each system call table modification, each hidden process and each hidden file associated with the exploit, said system comprising:
(a) restoring each system call table modification which has been identified by the exploitation detection component;
(b) terminating each hidden process which has been identified by the exploitation detection component; and
(c) removing from the operating system each hidden file which has been identified by the exploitation detection component.

7. A system for recovering from an operating system exploit following detection thereof by an exploitation detection component that is capable of identifying each system call table modification, each hidden process and each hidden file associated with the exploit, said system comprising:
(a) storage means;
(b) output means; and
(c) processing means for:
(i) restoring each system call table modification which has been identified by the exploitation detection component;
(ii) terminating each hidden process which has been identified by the exploitation detection component; and
(iii) removing from the operating system each hidden file which has been identified by the exploitation detection component.

8. A system according to claim 1 wherein each system call table modification corresponds to a legitimate lookup address for a respective system call table function being patched over with a illegitimate lookup address, and wherein restoration of each said system call table modification entails replacing the said illegitimate lookup address with the legitimate lookup address.

9. A system according to claim 1 wherein each respective hidden process is characterized by a memory management structure, a file descriptor structure and a file system structure, and wherein termination of each respective hidden process entails removing all pointers to the memory management structure, the file descriptor structure and the file system structure, and thereafter transmitting a termination signal to the respective hidden process.

10. A computer-readable medium for use in recovering from an operating system exploit following detection thereof, said computer-readable medium comprising a loadable kernel module having executable instructions for performing a method comprising:
(a) restoring each system call table modification which has been identified;
(b) terminating each hidden process which has been identified; and
(c) removing from the operating system each hidden file which has been identified.
